(19) United States
(12) Patent Application Publication
(10) Pub. No.: US 2008/0005202 A1
(43) Pub. Date: Jan. 3, 2008

(54) Method and system of digital right backuping and recovering

(75) Inventors: Zhensheng Zhang, Shenzhen (CN); Yingwei Li, Shenzhen (CN); Zhiquan Yuan, Shenzhen (CN)

Correspondence Address: LADAS & PARRY, 26 WEST 61ST STREET, NEW YORK, NY, 10023, US

(73) Assignee: HUA WEI TECHNOLOGIES CO., LTD.

(21) Appl. No.: 11/811,870

(22) Filed: Jun. 12, 2007

(30) Foreign Application Priority Data
Jun. 13, 2006 (CN) 200610087210.4

(51) Int. Cl. G06F 17/30

(52) U.S. Cl. 707/204; 707/E17.001

(57) ABSTRACT

A method of digital right backuping and recovery is disclosed, including: sending by User Equipment a digital right request message which includes request information of backupable and recoverable right to a provider server; sending by the provider server a backupable and recoverable digital right which is requested by the User Equipment to the User Equipment; confirming a digital right state by the User Equipment and the provider server; and sending by the provider server a backuped or recovered digital right to the User Equipment according to the digital right state when the User Equipment requests to backup or recover the digital right.

This application claims the priority of Chinese patent application No. 200610087210.4 filed with the Chinese Patent Office on Jun. 13, 2006, entitled “METHOD AND SYSTEM OF DIGITAL RIGHT BACKUPING AND RECOVERING”, contents of which are incorporated hereby by reference in its entirety.

### FIELD OF THE INVENTION

The present invention relates to right management technologies in the communication field, in particular, to a method and a system of digital right backuping and recovering.

### BACKGROUND OF THE INVENTION

In the digital communication field, carriers can control media files released to users by them according to a DRM (Digital Right Management) technology. For example, in an SD (Separate Delivery) of DRM 2.0 in the prior art, right objects and media objects are transmitted separately. A user purchases a right from a carrier server, the carrier server generates a customized user right, the right is sent to the user by the carrier server, the user installs the right, the user gets a DCF (DRM Content Format) file corresponding to the right from the carrier server or other mobile phones, and the DCF file is decrypted according to a key in the right to obtain a media file when the user uses the DCF file. Therefore, after a user obtains a media file contained in the DCF, the media file cannot be used directly until the user purchases the right from a carrier.

However, if the user's mobile phone or mobile equipment is lost, a new mobile phone can normally use the media file after the payment is newly made to the carrier and those rights belonging to the original mobile phone are obtained. Additionally, when the user deletes the rights in his/her mobile phone due to maloperation, the user needs to pay the carrier to gain those deleted rights again.

### SUMMARY OF THE INVENTION

The problems solved by one or more embodiments are to provide a method of digital right backuping and recovering to solve the defect in the prior art, namely, a user needs to repurchase a right when the right is lost.

An embodiment of the invention provides a method of digital right backuping and recovering, which includes the following processes: a provider server receives a digital right request message from User Equipment, which contains request information of backupable and recoverable right• a corresponding backupable and recoverable digital right is generated according to the request message and the corresponding backupable and recoverable digital right is sent to the User Equipment; the provider server sends a backuped digital right to the User Equipment when the User Equipment requests to recover the digital right; and the provider server and the User Equipment confirms a digital right state and determining whether the User Equipment possesses a right to use the backuped digital right.

An embodiment of the invention further provides a system of digital right backuping and recovering, which includes User Equipment and a provider server, wherein the User Equipment is used for verifying a backupable and recoverable digital right which is gotten from the provider server, and sending a digital right state confirmation request to the provider server at a scheduled time; and the provider server is used for generating the backupable and recoverable digital right which is needed by the User Equipment, downloading the digital right to the User Equipment, and determining the digital right state confirmation request sent by the User Equipment.

An embodiment of the invention further provides User Equipment of digital right backuping and recovering, which includes: a right type determining unit, for determining whether a digital right used by the User Equipment is the backupable and recoverable digital right; a right confirmation information generating unit, for generating confirmation information in the digital right; a right confirmation information state determining unit, for determining whether the confirmation information in the digital right information is valid; and a transceiving unit, for downloading the backupable and recoverable digital right from the provider server to the User Equipment or designated User Equipment, and sending the digital right state confirmation request to the provider server at a scheduled time or when the right information state determining unit determines the confirmation information in the digital right information is invalid.

An embodiment of the invention further provides A method for providing a backupable and recoverable digital right, including: generating a corresponding backupable and recoverable digital right according to types and contents of right which is needed by User Equipment;storing state information of the backupable and recoverable digital right; and receiving a digital right state confirmation request and determining whether a digital right state in the digital right state confirmation request is valid according to the state information, and notifying the User Equipment that the digital right is available when the digital right state is valid.

In an embodiment of the invention, after User Equipment is lost, new User Equipment is able to anew obtain a right which had been gotten from a carrier by the original User Equipment without making a payment again. Additionally, when a right of User Equipment is deleted due to maloperation, the right is able to be regained from the carrier without paying the carrier again. Moreover, after sending the right to the new User Equipment by the carrier, the use of the right is controlled by detecting a right signature, right time and right validity period to ensure that the right gotten originally in the lost User Equipment no longer is used.

Furthermore, when a capacity of the User Equipment is inadequate, the user is able to backup rights to the carrier server. Thus, in the future, the user should not need to pay the carrier again when the User Equipment needs to get those rights again.

### BRIEF DESCRIPTION OF THE DRAWINGS

FIG. 1 is a flow chart showing a method of digital right backuping and recovering according to an embodiment of the invention;

FIG. 2 is a flow chart showing a method for confirming a digital backup right according to the invention;

FIG. 3 is a flow chart for using a digital backup right by receiving equipment according to an embodiment of the invention;

FIG. 4 is a flow chart for confirming a digital right backuping and recovering by a provider according to an embodiment of the invention; and

FIG. 5 is a structural diagram of a system of digital right backuping and recovering according to an embodiment of the invention.

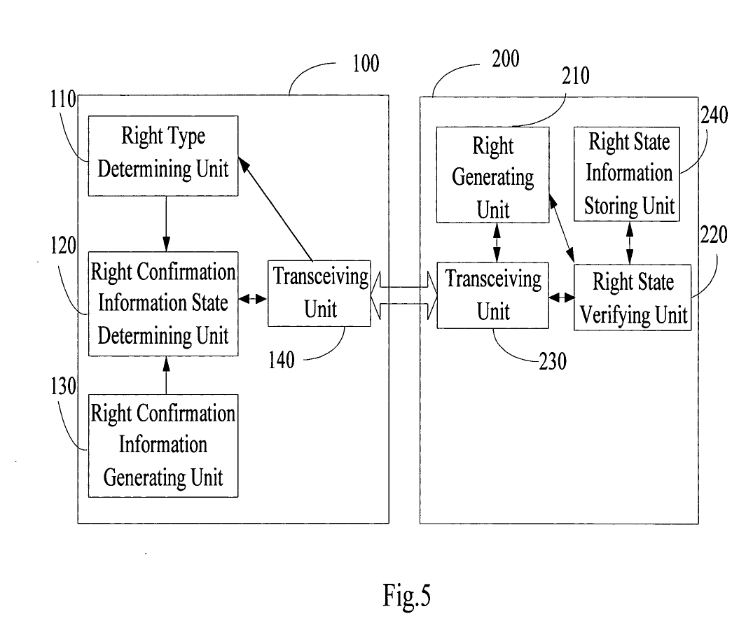

### DETAILED DESCRIPTION OF THE EMBODIMENTS

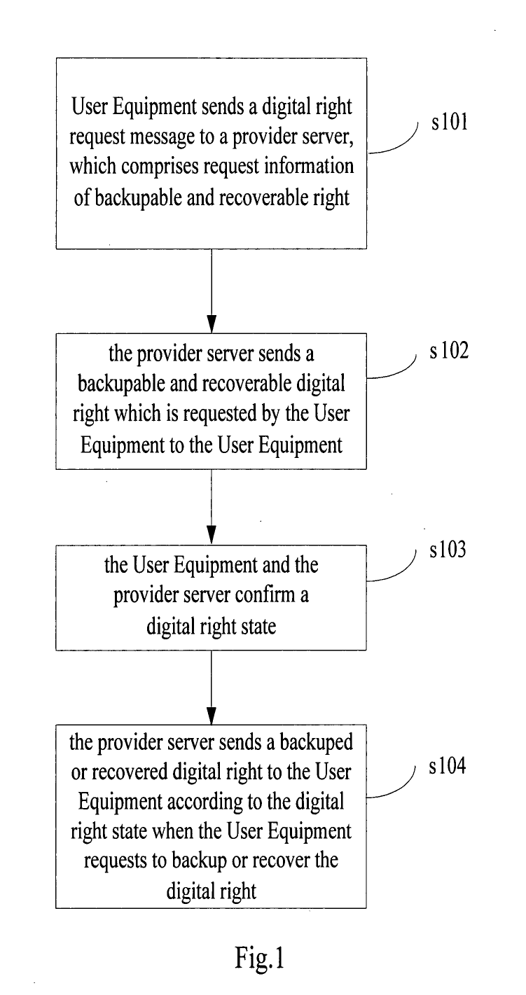

As shown in FIG. 1, an embodiment of the invention provides a method of digital right backuping and recovering, which includes the following processes:

In process s101, User Equipment sends a digital right request message to a provider server, which includes request information of a backupable and recoverable right. The information includes a type and contents of right needed by the User Equipment and a User Equipment account. An IMSI (International Mobile Subscriber Identity) designated by the User Equipment is stored in the User Equipment account, which can be a newly designated International Mobile Subscriber Identity or an original International Mobile Subscriber Identity. The newly designated International Mobile Subscriber Identity is obtained by means of logging in the provider server by inputting an account and a password, and modifying the original International Mobile Subscriber Identity.

In process s102, the provider server sends a backupable and recoverable digital right to the User Equipment, which is requested by the User Equipment. First of all, the provider server generates the backupable and recoverable digital right according to the type and contents of the right requested by the User Equipment, binds a digital right ID relating to the digital right with the User Equipment account, and finally, sends the digital right to User Equipment with the designated International Mobile Subscriber Identity according to the digital right ID. A format of recoverable right is obtained by modifying <!ELEMENT o-ex:context (o-dd:version?• •o-dd:uid*)> into <!ELEMENT o-ex:context (o-dd:version?• o•-dd:uid*• o•-dd:roConfirmUrl• •)>, and adding <!ELEMENT o-dd: roConfirmUrl (#PCDATA)>. The o-dd:roConfirmUrl (Digital right Confirmation Uniform Resource Locator) needs to be shown only when the right sent is recoverable, which belongs to URL (Uniform Resource Locator) type and is used for implementing a right confirmation when a right is used. <attribute name=“recover” type=“boolean”/> is added to ROPayload element, a corresponding message “RO Response ROAP (Right Object Acquisition Protocol)” is generated, and the attribute of recovery in ROPayload is set as “true”.

In process s103, the User Equipment and the provider server confirm the digital right state. In order to ensure the original right to be used uniquely by the User Equipment, the digital right state needs to be confirmed before the User Equipment uses the digital right.

In process s104, the provider server sends a backuped or recovered digital right to the User Equipment according to the digital right state when the User Equipment requests to backup or recover the digital right.

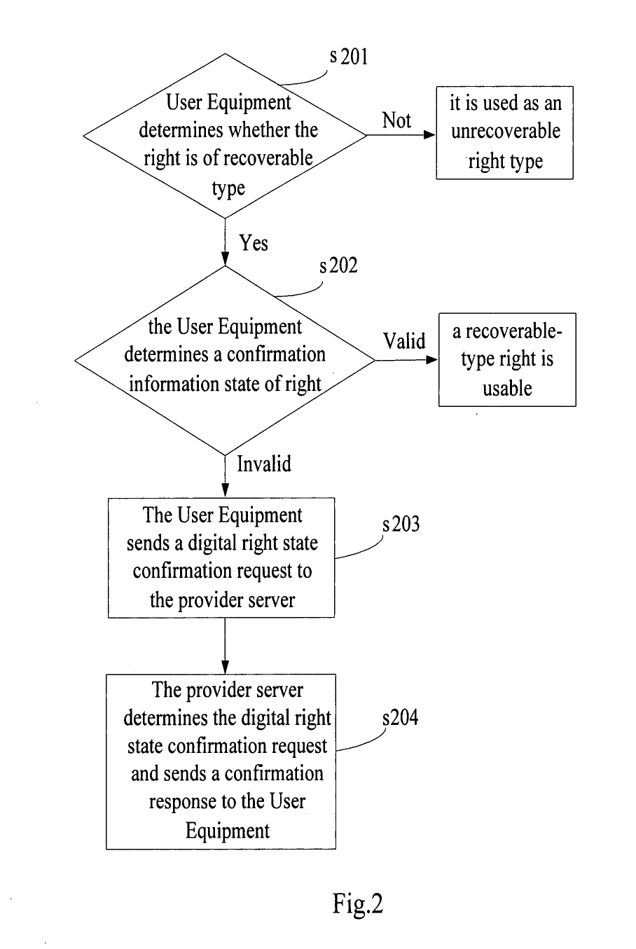

The process s103 further includes the following processes, as shown in FIG. 2.

In process s201, the User Equipment determines whether the right is recoverable. If it is recoverable, go to process s202. Otherwise, the right is used normally as an unrecoverable right.

In process s202, the User Equipment determines a confirmation information state of right. If the confirmation information state of right is not valid, go to process s203. If the confirmation information state of right is valid, the recoverable right is permitted to be used.

In process s203, the User Equipment sends a roConfirmRequest (digital right state confirmation request) to the provider server. The request message is shown in Table 1.

TABLE 1

| Parameter | Mandatory/Optional |
|---|---|
| Device ID | Mandatory |
| Domain ID | Optional |
| RI ID | Mandatory |
| Device Nonce | Mandatory |
| Request Time | Mandatory |
| roConfirmUrl | Mandatory |
| DeviceImsi | Mandatory |
| RecoverRo | Mandatory |
| Certificate Chain | Optional |
| Extensions | Optional |
| Signature | Mandatory |

In the table, the device ID (User Equipment ID) is used to identify a User Equipment address from which a request is issued, and value of the device ID needs to be equal to a mobile phone ID stored in the provider server. The domain ID refers to a domain to which the requested right pertain. The RI ID (provider server ID) refers to an address of the provider server which is requested, and its value must be equal to RI ID stored in the equipment. The Device Nonce (Random Data of User Equipment) refers to a nonce (random data) selected by the equipment as well as a method for generating the nonce and a method for using the nonce in a message. The Request Time refers to a current DRM time measured by the equipment. The roConfirmUrl (Digital right Confirmation Uniform Resource Locator) refers to o-dd in a right of recovery type, which is used for right confirmation; The Devicelmsi (International Mobile Subscriber Identity of User Equipment) refers to an International Mobile Subscriber Identity of a current mobile phone. The RecoverRo (Recovery Digital Right Object) refers to a recover-type right ID to be confirmed. The Certificate Chain is used for ensuring the confidentiality of invalid communication. The parameter “Certificate Chain” needs to be sent unless it is indicated in the RI context that necessary equipment certificate information has been stored in the RI. When the parameter is selected, its value should be the same as the parameter “Certificate Chain” in message “ROAP-Registration Request”.

Extension of a message “Ro Confirm Request” includes:

Peer Key Identifier (public key identifier) refers to an RI public key identifier stored in the equipment. If the identify is consistent with the stored RI ID or if the extension is null, it indicates that RI ID and its Certificate Chain are stored in the equipment, and RI does not need to send the Certificate Chain in a response message;

No OCSP Response means that RI does not need to send an OCSP (Online Certificate Status Protocol) response due to a valid OCSP response buffered by the equipment for the RI;

OCSP Responder Key Identifier identifies that an OCSP response key has been stored in the equipment. If this identifier is consistent with a certificate key used by an OCSP responser of RI, an OCSP responser certificate is able to be deleted from the OCSP response before an OCSP response is provided to the equipment. The Peer Key Identifier Extension needs to be sent only if an RI public key corresponding to the RI ID is stored in the equipment. The No OCSP Response Extension needs to be sent only if the equipment has a whole set of OCSP responses corresponding to the RI certificate. The OCSP Responder Key Identifier needs to be sent only if an OCSP response key corresponding to the RI is stored in the equipment. Both OCSP and Certificate Chain are used for maintaining validity of network certificate and terminal certificate, and the confidentiality and integrality of communications are guaranteed by the certificate, which cannot be modified.

The Signature refers to a signature on a message (except Signature element itself). The signature method includes making a unitary of the message (except the Signature element itself), taking result data of the unitary as input of the signature operation, and computing the result data according to a negotiated signature scheme and obtaining a signature result. The RI needs to verify a signature on a message “ROAP-RO ConfirmRequest”.

In process s204, the provider server determines the digital right state confirmation request, sends a confirmation response message “roConfirmResponse” to the User Equipment, and informs the User Equipment of validity and operable state of the recoverable right by related information in the response message. The response message is shown in Table 2.

TABLE 2

| | The State Is Successful | The State Is Failed |
|---|---|---|
| Status | Mandatory | Mandatory |
| Device ID | Mandatory | no |
| RI ID | Mandatory | no |
| Device Nonce | Mandatory | no |
| recoverRoConfirm | Mandatory | no |
| Certificate Chain | Optional | no |
| OCSP Response | Optional | no |
| Extensions | Optional | no |
| Signature | Mandatory | no |

In addition to some necessary equipment identifiers in the request message, the response message further includes the Status (state information), the recoverRoConfirm (right confirmation state information) and so on. The Status refers to whether the request is accomplished successfully. If it is not accomplished successfully, an error code can be sent to the equipment. The recoverRoConfirm further includes good, revoke, NotExist, Unknown and right time information. The “good” means that a right is usable, the “revoke” means that a right cannot be used, the “NotExist” means that a right does not exist, and the “Unknown” means that reasons are unknown. Right time information further includes thisUpdate, which means time to be updated this time; nextUpdate, which means time to be updated next time; and producedAt, which means time for generating a right.

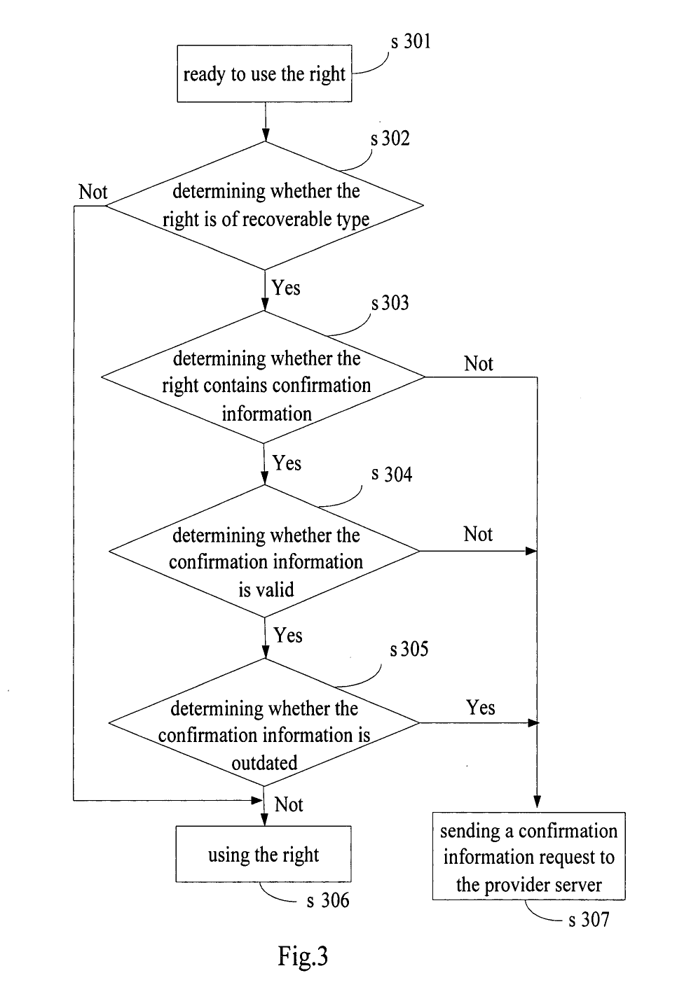

The above process s202 further includes the following processes, as shown in FIG. 3.

In process s301, the User Equipment gets ready to use the right.

In process s302, the User Equipment determines whether the right is recoverable according to a flag bit in the right information. If it is recoverable, go to process s303. Otherwise, go to process s306.

In process s303, the User Equipment determines whether the right contains the confirmation information. If it contains the confirmation information, go to process s304. Otherwise, go to process s307.

In process s304, the User Equipment determines whether the confirmation information is valid according to signature information in the right. If it is valid, go to process s305. Otherwise, go to process s307.

In process s305, the User Equipment determines whether the confirmation information is outdated according to the time information in the right. If it is not outdated, go to process s306. Otherwise, go to process s307.

In process s306, the right is used normally.

In process s307, a confirmation information request is sent to the provider server.

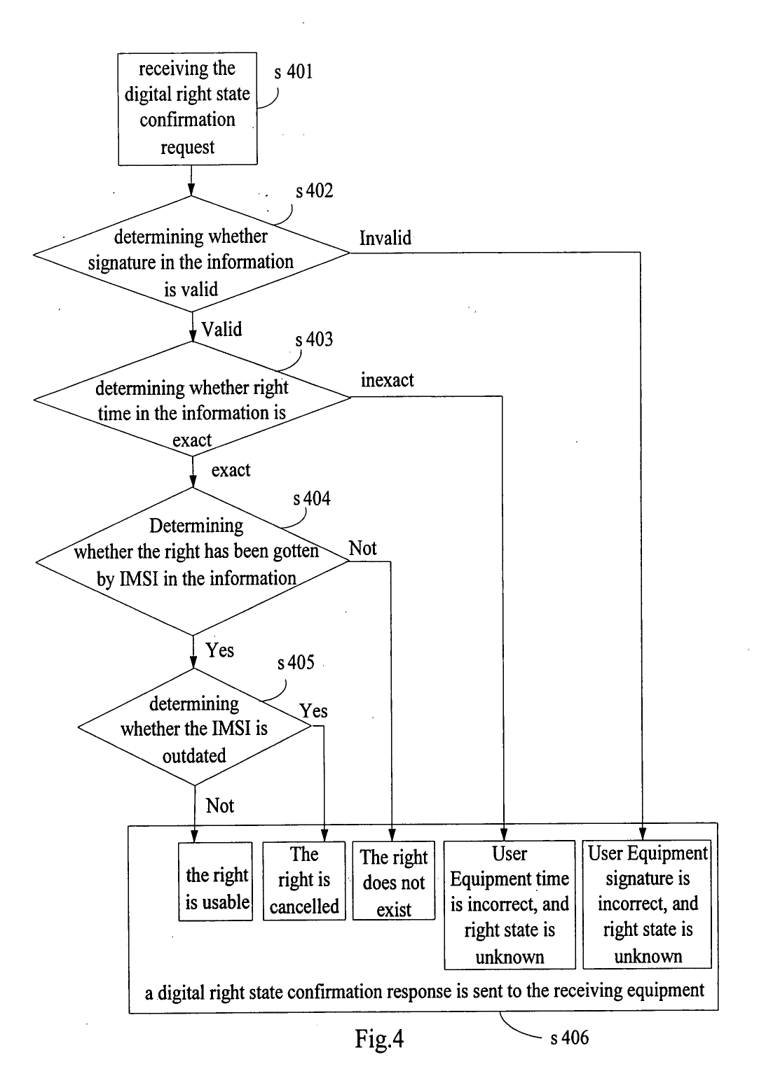

The process s204 further includes the following processes, as shown in FIG. 4.

In process s401, the provider server receives digital right state confirmation request information.

In process s402, the provider server determines whether its signature is valid according to signature information in the request information. If it is valid, go to process s403. Otherwise, go to process s406, in which the User Equipment is notified by ROAP response information that the signature is incorrect and the confirmation state is unknown, i.e. the right is invalid.

In process s403, the provider server determines whether a right time is exact according to the right time information in the request information. If it is exact, go to process s404. Otherwise, go to process s406, in which the User Equipment is notified by ROAP response information that the time is incorrect and the confirmation state is unknown, i.e. the right is invalid. At this moment, the User Equipment is able to obtain correct right time information by ROAP.

In process s404, the provider server determines whether a right has been sent according to the right ID and the International Mobile Subscriber Identity in the request information. If it is sent, go to process s405. Otherwise, go to process s406, in which the User Equipment is notified by ROAP response information that a confirmation state does not exist, i.e. the right is invalid.

In process s405, the provider server determines whether the digital right state confirmation request is outdated. If it is outdated, go to process s406, in which the User Equipment is notified by ROAP response information that the confirmation state is cancelled. Otherwise, the right is confirmed to be valid.

The embodiment of the invention further provides a system of digital right backuping and recovery, which includes User Equipment 100 and a provider server 200. The User Equipment 100 is used for verifying a backupable and recoverable digital right provided by the provider server 200 and confirmation information therein. If the digital right is backupable and recoverable and the confirmation information is valid, the digital right will be used normally. Otherwise, a digital right state confirmation request will be sent to the provider server 200. The provider server 200 is used for generating the backupable and recoverable digital right which is needed by the User Equipment, sending the digital right to the User Equipment 100, and determining the digital right state confirmation request information sent by the User Equipment 100.

The User Equipment 100 further includes a right type determining unit 110, a right confirmation information state determining unit 120, a right confirmation information generating unit 130 and a transceiving unit 140. The right type determining unit 110 is used for determining whether a digital right used by the User Equipment 100 is the backupable and recoverable digital right. The right confirmation information generating unit 130 is used for generating confirmation information in the digital right. The right confirmation information state determining unit 120 is used for determining whether the confirmation information in the digital right information is valid. If it is valid, the digital right will be used normally. Otherwise, the digital right state confirmation request will be sent to the provider server 200 by transceiving unit 140, and the backupable and recoverable digital right will be gotten from the provider server 200 to the User Equipment 100 or other designated User Equipment.

The provider server 200 further includes a right generating unit 210, a right state verifying unit 220, a transceiving unit 230 and a right state information storing unit 240. The right generating unit 210 is used for generating a backupable and recoverable digital right according to a type and contents of right needed by the user. The right state verifying unit 220 is used for determining whether information in the digital right state confirmation request is valid. If it is valid, the User Equipment 100 will be notified that the digital right is available by transceiving unit 230. The right state information storing unit 240 is used for storing state information of the backupable and recoverable digital right. The state information of digital right is used to determine whether the number of times using the digital right exceeds a predetermined number, whether the time period using the digital right exceeds a predetermined time period, whether a signature in the request information is valid, whether the time in the request information is exact, determining by a right ID and an International Mobile Subscriber Identity in the request information whether a right has been gotten, and whether the International Mobile Subscriber Identity in the request information is outdated, etc.

Only the preferred embodiments of the invention are described above. Accordingly, for those skilled in the art, various modifications and variations can be made without departing from the theory of the invention, which should fall in the protection scope of the invention.

1. A method of digital right backuping and recovering, comprising:
receiving, by a provider server, a digital right request message from User Equipment, which contains request information of backupable and recoverable right• •
generating a corresponding backupable and recoverable digital right according to the request message and sending the corresponding backupable and recoverable digital right to the User Equipment;
sending, by the provider server, a backuped digital right to the User Equipment when the User Equipment requests to recover the digital right; and
confirming, by the provider server and the User Equipment, a digital right state and determining whether the User Equipment possesses a right to use the backuped digital right.

2. The method of digital right backuping and recovering according to claim 1, wherein the generating the corresponding backupable and recoverable digital right according to the request of the User Equipment further comprises:
generating, by the provider server, the backupable and recoverable digital right according to a type and contents of right which is requested by the User Equipment; and
binding a digital right ID corresponding to the digital right with a User Equipment account.

3. The method of digital right backuping and recovering according to claim 2, wherein the sending by the provider server the backuped digital right to the User Equipment comprises:
sending, by the provider server, the digital right to the User Equipment with a designated International Mobile Subscriber Identity according to the digital right ID.

4. The method of digital right backuping and recovering according to claim 2, wherein the International Mobile Subscriber Identity is a newly designated International Mobile Subscriber Identity or an original International Mobile Subscriber Identity.

5. The method of digital right backuping and recovering according to claim 3, wherein the newly designated International Mobile Subscriber Identity is obtained by means of modifying the original International Mobile Subscriber Identity by the provider server.

6. The method of digital right backuping and recovering according to claim 1, wherein the confirming by the provider server and the User Equipment the digital right state comprises:
sending, by the User Equipment, a digital right state confirmation request which comprises signature information, right time and right validity period to the provider server; and
determining, by the provider server, the digital right state confirmation request and sending a confirmation response to the User Equipment.

7. The method of digital right backuping and recovering according to claim 6, the confirming by the provider server and the User Equipment the digital right state further comprises:
determining, by the User Equipment, whether the right is recoverable before the User Equipment sends the digital right state confirmation request to the provider server; if the right is recoverable, determining whether a confirmation information state of right is valid; if a the confirmation information state of right is invalid, sending the digital right state confirmation request to the provider server.

8. The method of digital right backuping and recovering according to claim 7, wherein the determining whether the confirmation information state of right is valid further comprises:
determining whether the right contains confirmation information; if the right contains the confirmation information, determining whether the confirmation information is normal and the confirmation information is outdated; if the confirmation information is normal and the confirmation information is not outdated, determining the confirmation information to be valid; if the confirmation information is abnormal and the confirmation information is overtime, determining the confirmation information to be invalid.

9. The method of digital right backuping and recovering according to claim 6, wherein the determining by the provider server the digital right state confirmation request and sending a confirmation response to the User Equipment further comprises:
determining whether a signature in the request information is valid, a time in the request information is exact, a right has been gotten according to a right ID and an International Mobile Subscriber Identity in the request information, and the International Mobile Subscriber Identity is outdated; if the signature in the request information is valid, the time in the request information is exact, the right has been gotten according to a right ID and an International Mobile Subscriber Identity in the request information, and the International Mobile Subscriber Identity is not outdated, determining the right to be valid; otherwise, notifying the User Equipment that the right is invalid by the Right Object Acquisition Protocol response information.

10. The method for a digital right backuping and recovering according to claim 9, wherein, if the User Equipment time is incorrect, modifying User Equipment time by the Rights Object Acquisition Protocol.

11. A system of digital right backuping and recovering, which comprises User Equipment and a provider server, wherein• •
the User Equipment is used for verifying a backupable and recoverable digital right which is gotten from the provider server, and sending a digital right state confirmation request to the provider server at a scheduled time; and
the provider server is used for generating the backupable and recoverable digital right which is needed by the User Equipment, providing it to the User Equipment, and determining the digital right state confirmation request sent by the User Equipment.

12. The system of digital right backuping and recovering according to claim 11, wherein the User Equipment further comprises:
a right type determining unit, for determining whether a digital right used by the User Equipment is the backupable and recoverable digital right;
a right confirmation information generating unit, for generating confirmation information in the digital right;
a right confirmation information state determining unit, for determining whether the confirmation information in the digital right information is valid; and
a transceiving unit, for downloading the backupable and recoverable digital right from the provider server to the User Equipment or designated User Equipment, and sending the digital right state confirmation request to the provider server when the right information state determining unit determines the confirmation information in the digital right information is invalid.

13. The system of digital right backuping and recovering according to claim 11, wherein the provider server further comprises:
a transceiving unit, for communicating with the USER Equipment;
a right generating unit, for generating the corresponding backupable and recoverable digital right according to types and contents of right which is needed by the User Equipment;
a right state information storing unit, for storing state information of the backupable and recoverable digital right; and
a right state verifying unit, for verifying whether a digital right state in the digital right state confirmation request is valid, and the transceiving unit notifies the User Equipment that the digital right is available when the digital right state is valid.

14. The system of digital right backuping and recovery according to claim 13, wherein the digital right state information is used to determine whether the number of times using the digital right exceeds a predetermined number, whether a time period using the digital right exceeds a predetermined time period, whether a signature in the request information is valid, whether a time in the request information is exact determining whether a right has been gotten by an International Mobile Subscriber Identity and a right ID in the request information, and whether the International Mobile Subscriber Identity in the request information is outdated.

15. User Equipment of digital right backuping and recovering, comprising:
a right type determining unit, for determining whether a digital right used by the User Equipment is the backupable and recoverable digital right;
a right confirmation information generating unit, for generating confirmation information in the digital right;
a right confirmation information state determining unit, for determining whether the confirmation information in the digital right information is valid; and
a transceiving unit, for downloading the backupable and recoverable digital right from the provider server to the User Equipment or designated User Equipment, and sending the digital right state confirmation request to the provider server at a scheduled time or when the right information state determining unit determines the confirmation information in the digital right information is invalid.

16. A method for providing a backupable and recoverable digital right, comprising:
generating a corresponding backupable and recoverable digital right according to types and contents of right which is needed by User Equipment;
storing state information of the backupable and recoverable digital right; and
receiving a digital right state confirmation request and determining whether a digital right state in the digital right state confirmation request is valid according to the state information, and
notifying the User Equipment that the digital right is available when the digital right state is valid.

17. The method for providing a backupable and recoverable digital right according to claim 16, further comprising:
binding a digital right ID corresponding to the digital right with a User Equipment account and sending the digital right to the User Equipment with a designated International Mobile Subscriber Identity according to the digital right ID.

18. The method for providing a backupable and recoverable digital right according to claim 17, wherein the state information of digital right comprises the number of times using the digital right, the time period using the digital right, a signature, a right ID and an International Mobile Subscriber Identity.

19. The method for providing a backupable and recoverable digital right according to claim 17, wherein determining whether a digital right state in the digital right state confirmation request is valid according to the state information comprises:
determining whether a signature in the request information is valid, a time in the request information is exact, a right has been gotten according to a right ID and an International Mobile Subscriber Identity in the request information, and the International Mobile Subscriber Identity is outdated; if the signature in the request information is valid, the time in the request information is exact, the right has been gotten according to a right ID and an International Mobile Subscriber Identity in the request information, and the International Mobile Subscriber Identity is not outdated, determining the digital right state is valid.
